(19) United States
(12) Patent Application Publication
(10) Pub. No.: US 2011/0090165 A1
(43) Pub. Date: Apr. 21, 2011

(54) INTERFACE METHOD AND DISPLAY DEVICE

(75) Inventor: Chang-seok OH, Suwon-si (KR)

(73) Assignee: Samsung Electronics Co., Ltd., Suwon-si (KR)

(21) Appl. No.: 12/905,724

(22) Filed: Oct. 15, 2010

(30) Foreign Application Priority Data
Oct. 16, 2009 (KR) 10-2009-0098877

(51) Int. Cl. G06F 3/041

(52) U.S. Cl. 345/173

(57) ABSTRACT

Disclosed is an interface method including detecting a contact on a display unit on which a first screen is output; determining whether a plurality of selectable objects exist within a first threshold distance from a point where the contact is detected; and outputting a second screen, in which at least one of the plurality of selectable objects are rearranged to provide distances between the plurality of selectable objects greater than or equal to a second threshold distance, on the display unit.

### PRIORITY

This application claims priority under 35 U.S.C. §119 to Korean Patent Application No. 10-2009-0098877, filed on Oct. 16, 2009, in the Korean Intellectual Property Office, the disclosure of which is incorporated herein in its entirety by reference.

### BACKGROUND OF THE INVENTION

1. Field of the Invention

The present invention relates to display devices and interface methods, and more particularly, to a display device including a display unit and an interface method in the display device.

2. Description of the Related Art

Various types of mobile devices are being equipped with rapidly developing information and communication technologies. When a user selects a mobile device, portability is one of a number of important factors.

Also, various ways to provide a user with an intuitive and easy interface are being researched, with display units including touch sensors installed in the mobile devices, with which the user performs a desired operation by touching the display unit, providing an advantage of reducing the mobile device that has a small size.

### SUMMARY OF THE INVENTION

The present invention provides an efficient display device and an efficient interface method in a display device.

According to a preferred embodiment of the present invention, there is provided an interface method including detecting a contact on a display unit on which a first screen is output; determining whether a plurality of selectable objects exist within a first threshold distance from a point where the contact is detected; and outputting a second screen, in which at least one of the plurality of selectable objects are rearranged in such a way that distances between the plurality of selectable objects are greater than or equal to a second threshold distance, on the display unit.

The interface method may further include, if one of the plurality of selectable objects is selected while the second screen is output, controlling the display unit to hide the second screen.

According to another embodiment of the present invention, there is provided a data output device including a display unit to which a first screen is output; a contact detector for detecting a contact on the display unit; a determiner for determining whether a plurality of selectable objects exist within a first threshold distance from a point where the contact is detected; and an output unit for outputting a second screen, in which at least one of the plurality of selectable objects are rearranged in such a way that distances between the plurality of selectable objects are greater than or equal to a second threshold distance, on the display unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a data output device according to an embodiment of the present invention;

FIGS. 2A and 2B illustrate a method of setting a first threshold distance, according to an embodiment of the present invention;

FIGS. 3A to 3C illustrate an operation of an output unit, according to an embodiment of the present invention;

FIGS. 4A to 4C illustrate another operation of the output unit, according to an embodiment of the present invention;

FIGS. 5A to 5C illustrate another operation of the output unit, according to an embodiment of the present invention;

FIG. 6 is a flowchart illustrating an interface method according to an embodiment of the present invention; and

FIG. 7 is a flowchart illustrating an interface method according to another embodiment of the present invention.

### DETAILED DESCRIPTION OF EMBODIMENTS OF THE INVENTION

Hereinafter, the present invention will be described more fully with reference to the accompanying drawings, in which embodiments of the invention are shown.

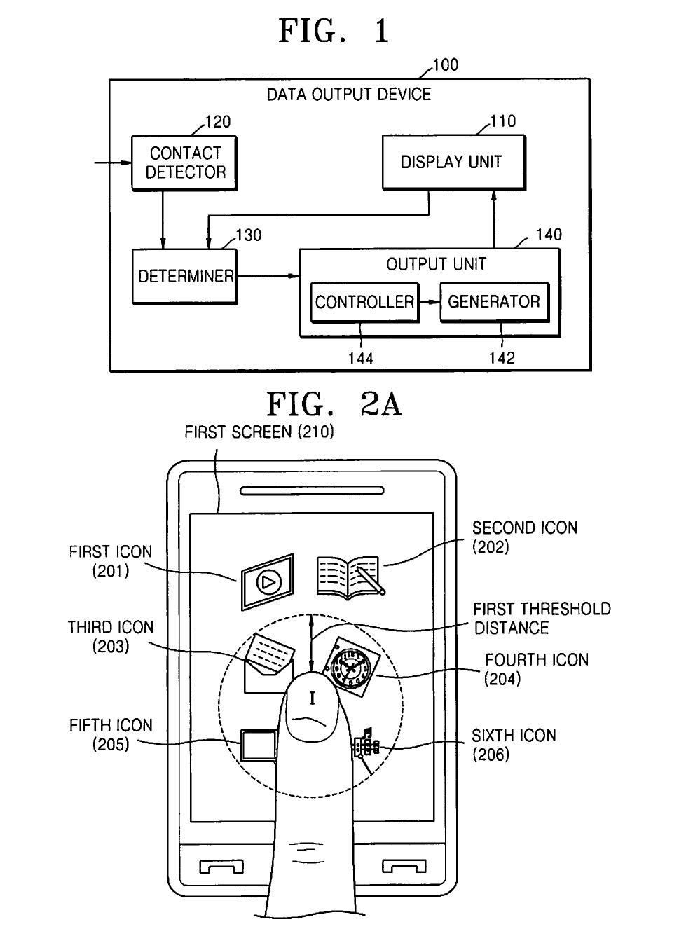

As shown in FIG. 1, a data output device 100 is provided that includes a display unit 110, a contact detector 120, a determiner 130, and an output unit 140.

The display unit 110 outputs an interface screen to induce a user's selection.

The contact detector 120 detects a contact on the display unit 110. The contact detector 120 may include a sensor, such as a touch sensor using an electrostatic capacity sensor or a compression sensor, for detecting contact on the display unit 110. The contact detector 120 detects the contact of a finger of the user or of a touch pen.

The determiner 130 determines whether a plurality of selectable objects exist within a first threshold distance from a location of a point where the contact is detected. Here, the selectable objects denote components selectable by the user, from among components displayed on the display unit 110. For example, examples of the selectable objects may include icons and texts with links.

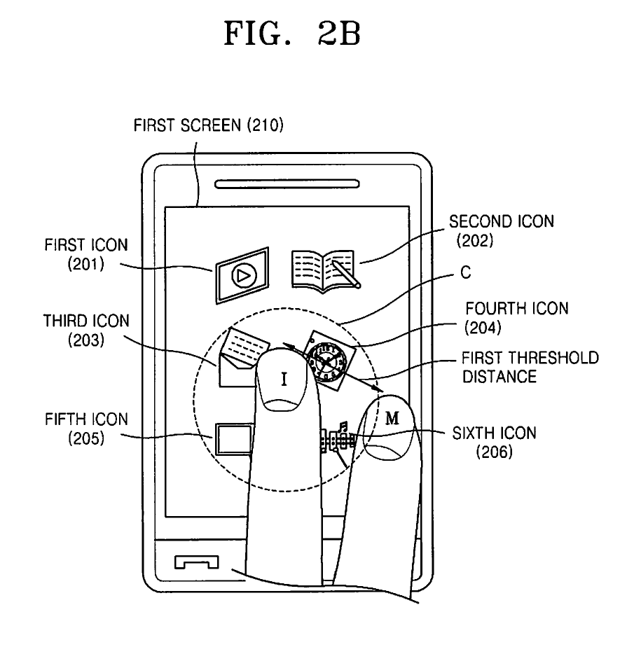

The determiner 130 presets the first threshold distance. The user may change the first threshold distance with a desired value by a number of methods, with two of these methods described below. First, the user may designate the first threshold distance by manually inputting a desired value. Here, the first threshold distance maintains a predetermined value unless changed by the user. Second, the user may set the first threshold distance to a desired value every time by using multiple touches. For example, the user may set the first threshold distance by setting a reference point using the user's index finger and then dragging the user's middle finger. Setting of the first threshold distance is described in detail with reference to FIG. 2.

The determiner 130 determines whether distances between the selectable objects within the first threshold distance from the point where the contact is detected are within a second threshold distance. When the selectable objects are adjacent to each other, locations of the selectable objects may be adjusted so that the user easily selects a desired object. However, if the selectable objects are not adjacent to each other, the locations of the selectable objects may not be adjusted since the user is able to easily select the desired object.

The output unit 140 outputs a second screen, in which at least one of the selectable objects are rearranged to provide distances between the selectable objects equal to or above the second threshold distance, on the display unit 110.

In a preferred embodiment, the output unit 140 includes a generator 142 and a controller 144, as shown in FIG. 1.

The generator 142 generates the second screen by adjusting a location of at least one selectable object to provide the distances between the selectable objects in the first screen equal to or above the second threshold distance. The second screen may be identical to the first screen except that the location of the at least one selectable object is adjusted. Alternatively, the generator 142 may extract the selectable objects within the first threshold distance from the point where the contact is detected, and may generate the second screen including only the selectable objects.

The controller 144 may control the display unit 110 to simultaneously output the first and second screens or to change the first screen to the second screen. When the first and second screens are simultaneously output, the first and second screens may be hierarchically output.

When predetermined conditions are satisfied after the second screen is output, the controller 144 controls the display unit 110 to output a previous screen, i.e., the first screen. For example, the controller 144 controls the display unit 110 to output the previous screen if the user selected one of the selectable objects in the second screen, if the user did not select any selectable object until a predetermined time elapses, or if the user performs a predetermined operation, such as scrolling down.

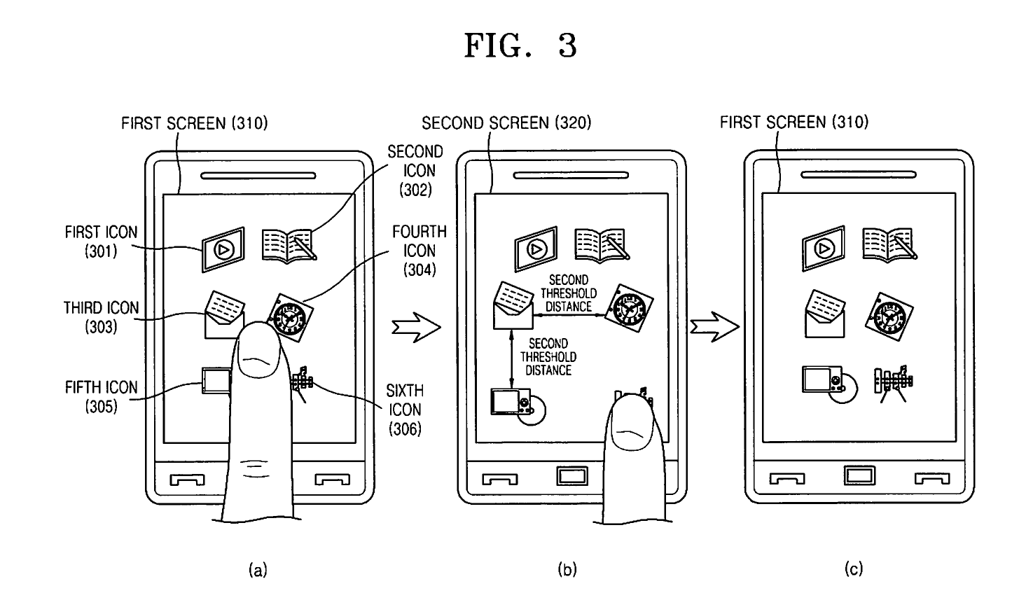

Operations of the controller 144 related to a screen switch are described with reference to FIGS. 3 through 5. As shown in FIGS. 2A-2B, a first screen 210 output on the display unit 110 displays first through sixth icons 201 through 206 as objects.

In FIG. 2A, a user has directly input a value of the first threshold distance, or the first threshold distance is set to an initial value.

As shown in FIG. 2A, a finger of the user contacts the display unit 110 on which the first screen 210 is output. The determiner 130 determines whether at least two objects exist within a circle of the first threshold distance based on a point where the contact is detected. In FIG. 2A, the third through sixth icons 203 through 206 are within the first threshold distance from the point where the contact is detected.

In FIG. 2B, the user sets the first threshold distance using a multi touch. The user contacts the display unit 110 on which the first screen 210 is output with an index finger “I”, and sets the first threshold distance by dragging a middle finger “M”. The determiner detects whether a plurality of objects exist within a circle “C” having a radius from a point where the index finger is contacting to a location where the middle finger is dragged. In FIG. 2B, the third icon 203 through the sixth icon 206 are within the first threshold distance from the point where the index finger contact is detected.

The user sets the first threshold distance by using multi touch in FIG. 2B, but alternatively, the first threshold distance may be set by changing an interface mode to a first threshold distance setting mode, and performing a switching of screens, as described below.

Switching of screens displayed on the display unit 110 according to user's manipulation will be described with reference to FIGS. 3A-3C.

A first screen 310 is initially output on the display unit 110. First through sixth icons 301 through 306 are displayed on the first screen 310 as objects. The user places a finger in contact between the third icon 303 and the sixth icon 306. The determiner 130 determines whether a plurality of objects exist within the first threshold distance from the point where the finger contacts. Also, the determiner 130 determines whether distances between the objects within the first threshold distance are within the second threshold distance. In FIG. 3, the third through sixth icons 303 through 306 exist within the first threshold distance, and the distances between the third through sixth icons 303 through 306 are within the second threshold distance.

Accordingly, the output unit 140 outputs a second screen 320. In detail, the generator 142 generates the second screen 320 by moving a location of at least one of the third through sixth icons 303 through 306 to provide distances between each of the third through sixth icons 303 through 306 that are greater than or equal to the second threshold distance. The controller 144 controls the display unit 110 to change a screen being output on the display unit 110 from the first screen 310 to the second screen 320.

The user then selects the sixth icon 306 from among the first through sixth icons 301 through 306 in the second screen 320. When the user selects this one object in the second screen 320, the controller 144 controls the display unit 110 to change the screen being output on the display unit 110 from the second screen 320 to the first screen 310. Accordingly, the first screen is again output on the display unit 110.

In the first screen 310, the user may select an undesired object since the first through sixth objects 301 through 306 are displayed adjacent to each other. However, in the data output device 100 according to an embodiment of the present invention, the user is able to accurately select a desired object since the second screen 320, in which the locations of the third through sixth objects 303 through 306 are adjusted, is output.

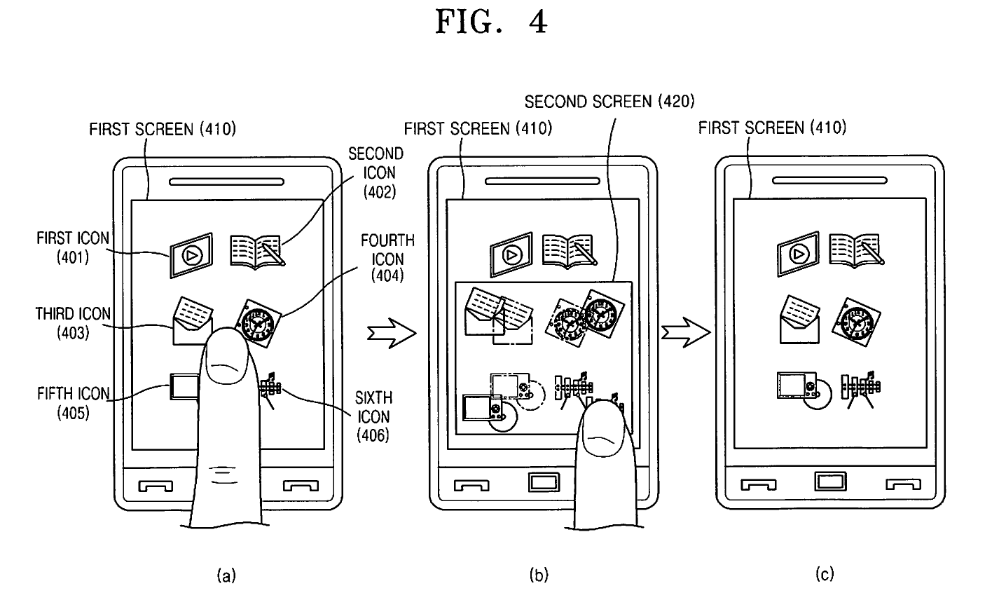

As shown in FIGS. 4A-4C, describing another operation of the output unit 140, a first screen 410 is initially output on the display unit 110. First through sixth icons 401 through 406 are displayed on the first screen 410 as objects. The user places a finger in contact between the third and sixth icons 403 and 406. In FIG. 4, the third through sixth icons 403 through 406 are within the first threshold distance from the point where the finger contacts, and the distances between the third through sixth icons 403 through 406 are within the second threshold distance.

The generator 142 generates a second screen 420 by moving a location of at least one of the third through sixth icons 403 through 406 to provide distances between the third through sixth icons 403 through 406 that are each greater than or equal to the second threshold distance. Here, the second screen 420 is configured so that only the third through sixth icons, 403 through 406, which are within the first threshold distance, are included in the second screen 420.

The controller 144 controls the display unit 110 to hierarchically output the first and second screens 410 and 420. For example, the first and second screens 410 and 420 may be separate layers, and may be output while overlapping with each other. In FIG. 4, the first screen 410 is a lower layer and the second screen 420 is an upper layer. Accordingly, icons displayed in dotted lines are hidden icons in the first screen 410, and icons displayed in solid lines are exposed icons.

The user then selects the sixth icon 406 from among the first through sixth icons 401 through 406 in the second screen 420. When the user selects this one object in the second screen 420, the second screen 420 disappears from the display unit 110, and only the first screen 410 is output on the display unit 110.

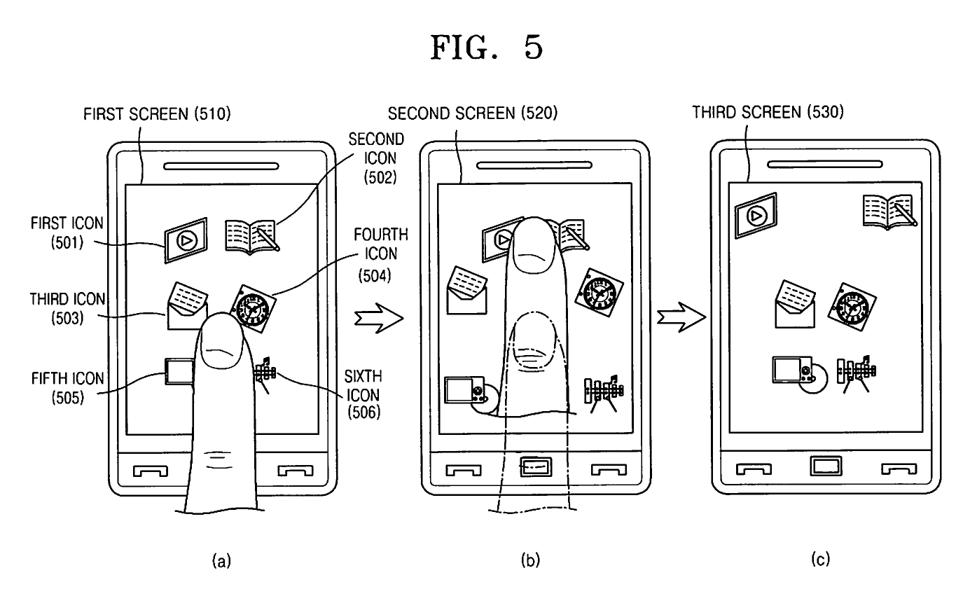

As shown in FIGS. 5A-5C, in regard to another operation of output unit 140, a first screen 510 is initially output on the display unit 110. First through sixth icons 501 through 506 are displayed on the first screen 510 as objects. The user places a finger in contact between the third icon 503 and the sixth icon 506. In FIG. 5, the third through sixth icons 503 through 506 are within the first threshold distance from a point where the finger contacts, and distances between the third through sixth icons 503 through 506 are within the second threshold distance.

The generator 142 generates a second screen 520 by moving a location of at least one of the third through sixth icons 503 through 506 to provide distances between the third through sixth icons 503 through 506 that are each greater than or equal to the second threshold distance. The controller 144 controls the display unit 110 to change a screen being output on the display unit 110 from the first screen 510 to the second screen 520.

Then, the user drags the finger toward and between the first and second icons 501 and 502, as shown in FIG. 5B. The generator 142 generates a third screen 530 by moving a location of at least one of the first and second icons 501 and 502 to provide a distance between the first and second icons 501 and 502 greater than or equal to the second threshold distance. The controller 144 controls the display unit 110 to change the screen being output from the second screen 520 to the third screen 530, as shown in FIG. 3C.

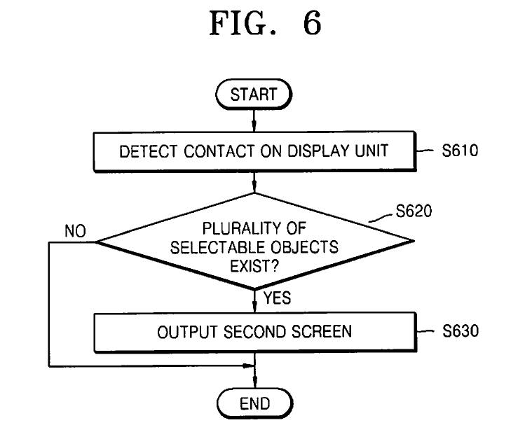

As shown in FIG. 6, in step S610, a contact on a display unit, on which a first screen is output, is detected.

In step S620, it is determined whether a plurality of selectable objects exist within a first threshold distance from a point where the contact is detected.

In step S630, a second screen, in which at least one of the selectable objects is rearranged in such a way that distances between the selectable objects are greater than or equal to a second threshold distance, is output. Here, the second screen is generated by adjusting the location of the at least one of the selectable objects in the first screen, and then a screen being output on the display unit may be changed from the first screen to the second screen or the first and second screens may be hierarchically output on the display unit.

Then, the display unit may be controlled to output the first screen again if a user selects one selectable object or if a threshold time has elapsed.

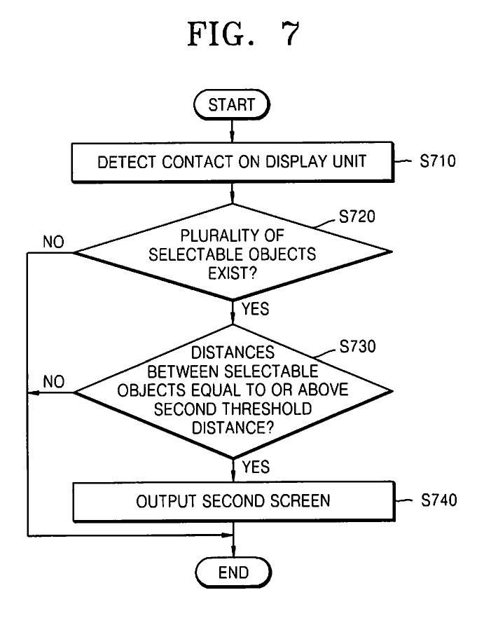

As shown in FIG. 7, in step S710, a contact on a display unit, on which a first screen is output, is detected.

In step S720, it is determined whether a plurality of selectable objects exist within a first threshold distance from a point where the contact is detected. If the selectable objects exist within the first threshold distance, step S730 is performed.

In step S730, it is determined whether distances between the selectable objects are within a second threshold distance. If the distances are within the second threshold distance, step S740 is performed.

In step S740, a second screen, in which at least one of the selectable objects is rearranged to provide distances between the selectable objects greater than or equal to the second threshold distance, is output.

One of ordinary skill in the art will recognize that the above-described embodiments of the present invention can be provided as computer programs and can be implemented in general-use digital computers that execute the programs using a computer readable recording medium. Examples of the computer readable recording medium include storage media such as magnetic storage media (e.g., ROM, floppy disks, hard disks, etc.) and optical recording media (e.g., CD-ROMs, or DVDs).

While this invention has been particularly shown and described with reference to embodiments thereof, it will be understood by those of ordinary skill in the art that various changes in form and details may be made therein without departing from the spirit and scope of the invention as defined by the appended claims. The embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An interface method comprising:
detecting a contact on a display unit on which a first screen is output;
determining whether a plurality of selectable objects exists within a first threshold distance from a point where the contact is detected; and
outputting to the display unit a second screen, on which at least one of the plurality of selectable objects are rearranged to provide distances between the plurality of selectable objects greater than or equal to a second threshold distance.

2. The interface method of claim 1, wherein the determining comprises determining whether the distances between the plurality of selectable objects are within the second threshold distance.

3. The interface method of claim 1, wherein the outputting comprises:
generating the second screen by adjusting a location of at least one of the plurality of selectable objects in the first screen so that the distances between the plurality of selectable objects are greater than or equal to the second threshold distance; and
controlling the display unit to change a screen being output on the display unit from the first screen to the second screen.

4. The interface method of claim 1, wherein the outputting comprises:
generating the second screen by adjusting a location of at least one of the plurality of selectable objects in the first screen so that the distances between the plurality of selectable objects are greater than or equal to the second threshold distance; and
controlling the display unit to hierarchically output the first screen and the second screen.

5. The interface method of claim 3, wherein the controlling comprises, if one of the plurality of selectable objects is selected while the second screen is output, controlling the display unit to change the screen being output on the display unit from the second screen to the first screen.

6. The interface method of claim 3, wherein the controlling comprises, if a threshold time elapses after the second screen is output, controlling the display unit to change the screen being output on the display unit from the second screen to the first screen.

7. The interface method of claim 4, further comprising, if one of the plurality of selectable objects is selected while the second screen is output, controlling the display unit to hide the second screen.

8. A data output device comprising:
a display unit to which a first screen is output;
a contact detector for detecting a contact on the display unit;
a determiner for determining whether a plurality of selectable objects exists within a first threshold distance from a point where the contact is detected; and
an output unit for outputting to the display unit a second screen, on which at least one of the plurality of selectable objects are rearranged to provide distances between the plurality of selectable objects greater than or equal to a second threshold distance.

9. The data output device of claim 8, wherein the determiner determines whether the distances between the plurality of selectable objects are within the second threshold distance.

10. The data output device of claim 8, wherein the output unit comprises:
a generator for generating the second screen by adjusting a location of at least one of the plurality of selectable objects in the first screen so that the distances between the plurality of selectable objects are greater than or equal to the second threshold distance; and
a controller for controlling the display unit to change a screen being output on the display unit from the first screen to the second screen.

11. The data output device of claim 8, wherein the output unit comprises:
a generator for generating the second screen by adjusting a location of at least one of the plurality of selectable objects in the first screen so that the distances between the plurality of selectable objects are greater than or equal to the second threshold distance; and
a controller for controlling the display unit to hierarchically output the first screen and the second screen.

12. The data output device of claim 10, wherein the controller, if one of the plurality of selectable objects is selected while the second screen is output, controls the display unit to change the screen being output on the display unit from the second screen to the first screen.

13. The data output device of claim 10, wherein the controller, if a threshold time elapses after the second screen is output, controls the display unit to change the screen being output on the display unit from the second screen to the first screen.

14. The data output device of claim 11, wherein the controller, if one of the plurality of selectable objects is selected while the second screen is output, controls the display unit to hide the second screen.

15. A computer readable recording medium having recorded thereon a program for executing an interface method comprising:
detecting a contact on a display unit;
determining whether a plurality of selectable objects exists within a first threshold distance from a point where the contact is detected; and
outputting a screen, on which at least one of the plurality of selectable objects are rearranged to provide distances between the plurality of selectable objects greater than or equal to a second threshold distance.
